(19) United States
(12) Patent Application Publication
(10) Pub. No.: US 2007/0240500 A1
(43) Pub. Date: Oct. 18, 2007

(54) Automotive Fuel Injector Leakage Tester

(76) Inventors: Anthony Phillip Pollard, Milton Keynes (GB); Andrew Eric Murray, Buckinghamshire (GB)

Correspondence Address: CLARK & BRODY, 1090 VERMONT AVENUE, NW, SUITE 250, WASHINGTON, DC, 20005, US

(21) Appl. No.: 10/577,071

(22) PCT Filed: Oct. 28, 2004
(86) PCT No.: PCT/GB04/04568

§ 371 Date: Mar. 16, 2007

(30) Foreign Application Priority Data
Oct. 28, 2003 (GB) 0325184.0

(51) Int. Cl. F02M 65/00

(52) U.S. Cl. 73/119 A

(57) ABSTRACT

An automotive fuel injector leakage tester (10) comprising a mount (22) for such an injector (32) and a flowmeter (66) of sufficient sensitivity arranged to measure leaked fuel flow rates through the nozzle (34) of such an injector (32). The tester (10) is further provided with an interface passageway (58) which enables fluid communication between the injector nozzle (34) and the flowmeter (66) when the tester (10) is in use. An injector (32) contains a first liquid when under test to supply such liquid to the injector nozzle (34) so that such liquid can leak therethrough into the interface passageway (58). The interface passageway (58) contains a second liquid which is immiscible with the first liquid, the tester (10) being so constructed that the interface between the first and second liquids remains within the interface passageway (58) whilst the flowmeter (66) provides a measure of the leakage of the first liquid through the nozzle (34) of such an injector (32). The invention extends to a method of testing an automotive fuel injector for leakage, a tester with a heat transfer detection flowmeter (in which the same liquid can flow through the injector as flows through the flowmeter), apparatus and a method of bringing two components together along a slanting imaginary line in a bath of liquid, and a master leak for calibrating an automotive fuel injector tester.

The present invention relates to an automotive fuel injector leakage tester comprising a mount for such an injector and a flowmeter of sufficient sensitivity arranged to measure leaked fuel flow rates through the nozzle of such an injector.

Hitherto, such a flowmeter in such a tester has comprised a source of pressurised gas applied to the upstream end of the injector with means to measure the rate of decay of pressure in the gas by virtue of leakage of gas through the nozzle of the injector.

One problem encountered by this prior apparatus is that any residual liquid present within the fuel injector can block or interfere with the flow of gas through the injector nozzle. As a consequence, some injectors which should fail the test may actually pass it. Alternatively, to reduce this risk, further equipment may be required to dry the injector before it is subjected to a test. This adds to the expense of the equipment.

Furthermore, gases do not behave in the same fashion as liquids as regards the leakage through the injector nozzle. In particular, a gas cannot be found that will entirely correspond to the behaviour of liquid fuel so far as leakage through the nozzle of the injector is concerned.

The present invention seeks to provide a remedy to one or more of these problems.

Accordingly, the present invention is directed to an automotive fuel injector leakage tester having the construction set out in the opening paragraph of the present specification, in which the tester is further provided with an interface passageway which enables fluid communication between the injector nozzle and the flowmeter when the tester is in use, in which such an injector contains a first liquid when under test to supply such liquid to the injector nozzle so that such liquid can leak therethrough into the interface passageway, and in which the interface passageway contains a second liquid which is immiscible with the first liquid, the tester being so constructed that the interface between the first and second liquids remains within the interface passageway whilst the flowmeter provides a measure of the leakage of the first liquid through the nozzle of such an injector.

As a result of such a construction, the liquid passing through the nozzle of the injector, which is likely to be constituted by or contaminated by a material which leaves a deposit on surfaces, does not come into contact with surfaces of the flowmeter. With the very low flow levels involved and consequential high sensitivity required for the flowmeter, such deposits could otherwise render measurements made by the flowmeter unacceptably inaccurate.

Preferably, the flowmeter also contains the said second liquid, so that it provides a measure of the leakage flow rate through the nozzle of the injector under test by virtue of displacement of the second liquid through it owing to the said first liquid displacing some of the said second liquid from the interface passageway.

Preferably, the injector is positioned above the interface passageway with the said first liquid being of a lower density than the said second liquid. The said first liquid may comprise a test oil, and the said second liquid may comprise water.

Preferably, the flowmeter comprises a measurement passageway of sufficiently small cross-section to enable a flow rate to be measured which is as low as automotive fuel injector leakage flow rates. Advantageously, the flowmeter measures flow rates via heat transfer detection means which serve to detect heat transferred by liquid passing through the measurement passageway, to provide a measure of the flow rate thereof. Thus, the measurement passageway may be provided with a heating element positioned to heat fluid within the measurement passageway, and a temperature sensor provided downstream of the heating element to provide an output which is indicative of the flow rate. The temperature sensor may, for example, comprise a thermocouple. A further temperature sensor may be arranged upstream of the heating element to provide a measure of the temperature of liquid flowing within the measurement passageway before it reaches the heating element. The flowmeter may then take account of the temperature of the incoming liquid, to adjust the output from the first temperature sensor accordingly so that the output of the flowmeter is substantially independent of the temperature of the incoming liquid. This second temperature sensor may also comprise a thermocouple. Clearly, with such an arrangement, the roles of the two temperature sensors may be selectively reversed so that the flowmeter can measure flow rates of liquids in both directions of flow through the measurement passageway. Alternatively, the flowmeter may comprise a micro turbine.

The interface passageway may comprise a tube connected to the flowmeter at one of its ends, and may be provided with a seal at its other end adapted for sealing engagement with the nozzle end of such an injector.

A reverse feed device may be connected in fluid communication with the flowmeter on the other side thereof to that of the injector. The reverse feed device may comprise a reservoir of the said second liquid to an upper surface of which is connected a source of pressurised gas to force the flow of fluid through the flowmeter in the reverse direction to which such fluid flows through the flowmeter during a leakage measurement. A control may be provided to ensure that the amount of liquid flowing through the flowmeter in the second direction is equal to the amount of fluid which flowed through it during the leakage measurement.

This enables prevention of liquid which passed through the injector under test contaminating the flowmeter.

Preferably, this returns the interface between the two liquids to the seal end of the interface passageway.

A drive may be provided to bring about relative linear movement between the injector and the interface passageway to bring them into and out of sealing engagement with one another.

It is desirable for the tester to have a bath of the said first liquid, and for that end of the interface passageway which is brought into contact with the injector to be immersed in that bath. This reduces the likelihood that air will become trapped between the injector nozzle and the interface passageway which could give a faulty measurement. The likelihood of such trapped air is reduced even further if the axis of the injector is aligned with the direction of relative movement between the injector and the interface passageway, if the nozzle end of the injector has a face which is generally transverse of that axis, and if this line of movement is on a slant so that as the nozzle end of the injector dips into the bath of the said first liquid, so that the line of contact between the generally horizontal surface of that liquid and the nozzle end of the injector sweeps across the face thereof, and more readily enables removal of air that might otherwise become trapped between the nozzle end of the injector and the interface passageway.

The present invention also extends to a method of testing an automotive fuel injector for leakage, using a tester made as set out in one or more of the foregoing paragraphs in accordance with the present invention.

Thus, the present invention extends to a method of testing an automotive fuel injector for leakage, in which a first liquid is allowed to leak from the nozzle of an injector under test into an interface passageway which contains a second liquid and which provides fluid communication between the injector nozzle and a flowmeter, the second liquid being immiscible with the first, and the interface between the first and second liquids remaining within the interface passageway whilst the flowmeter provides a measure of the leakage of the first liquid through the nozzle of such an injector.

The invention also extends to a method of bringing about a sealing engagement between two components in such a fashion as to reduce the likelihood of air being trapped between them, in which the two components are brought together by relative linear motion along a first imaginary line which is on a slant, and in which one end of the lower of the components is immersed in a bath of liquid, and in which the upper of the components has an end face which is transverse of that line, so that a second imaginary line, being the line of contact between the surface of the liquid and the said end face as the latter dips into the bath sweeps across that end face enabling air which would otherwise be trapped between the two components before they are brought together to escape.

The invention further extends to an automotive fuel injector leakage tester comprising a mount for such an injector and a flowmeter of sufficient sensitivity arranged to measure leaked fuel flow rates through the nozzle of such an injector, in which the flowmeter comprises a measurement passageway of sufficiently small cross-section to enable a flow rate to be measured which is as low as automotive fuel injector leakage flow rates, and heat transfer detection means which serve to detect heat transferred by liquid passing through the measurement passageway, to provide a measure of the flow rate thereof.

It is possible for the same fluid, for example water or alcohol, to be used as the fluid which passes at leakage flow rates through the nozzle of the injector, as well as the fluid which passes through the flowmeter.

The benefit of water or alcohol is that it can be obtained in a pure form and has low viscosity, reducing the likelihood of blockages in the fine tubing and in the leak pathway of the injector. It also increases the repeatability of the measured leak, improving the quality of the leak measurement and the measurement system's capability.

Master leaks have hitherto been produced by running standard injectors for many cycles until the leak rate is constant and the repeatability of the leak is not always good. The valve may be opened which may alter the leak characteristic on closure. Although sintered plugs may be used to produce known leaks, their repeatability is poor and they are difficult to produce for very low leak rates.

The invention therefore further extends to a master leak, comprising a capillary tube and pressure regulating means connected to apply pressure to a fluid within the capillary tube.

Preferably, the master leak has an outer shape which corresponds to that of an automotive fuel injector, so that it can readily be installed in an automotive fuel injector leakage tester.

The master leak may be provided with a filter to inhibit blockage of the capillary tube thereof. It may also be provided with an upper seal to simulate the injector upper seal.

Advantageously, the pressure regulating means comprise a regulator valve.

Preferably, the pressure regulating means comprise a head of fuel in a tube.

Preferably, the capillary tube has a diameter of between 0.2 mm and 0.025 mm.

The leak rate may be controlled by choosing a suitable diameter and length for the capillary tube.

The master leak apparatus may be used for calibrating the fuel injector leak tester as it may be controlled more precisely than repeatedly running standard injectors until the leak rate is relatively constant.

An example of an automotive fuel injector leakage tester made in accordance with the present invention will now be described with reference to the accompanying drawings, in which:

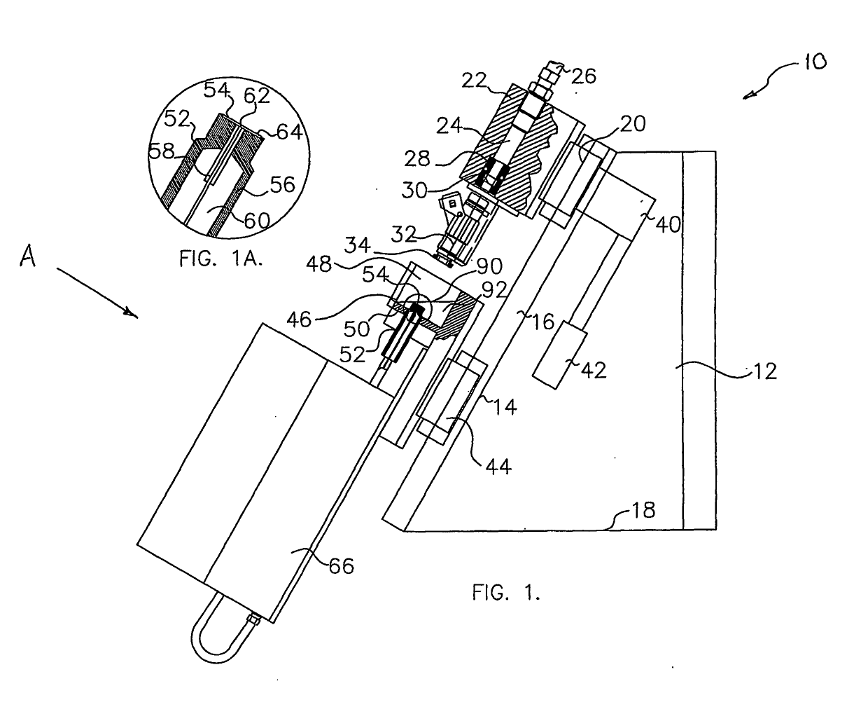

FIG. 1 is a part axial sectional part side view of such a tester;

FIG. 1a is an axial sectional view of a part of the tester shown in FIG. 1, drawn on a larger scale;

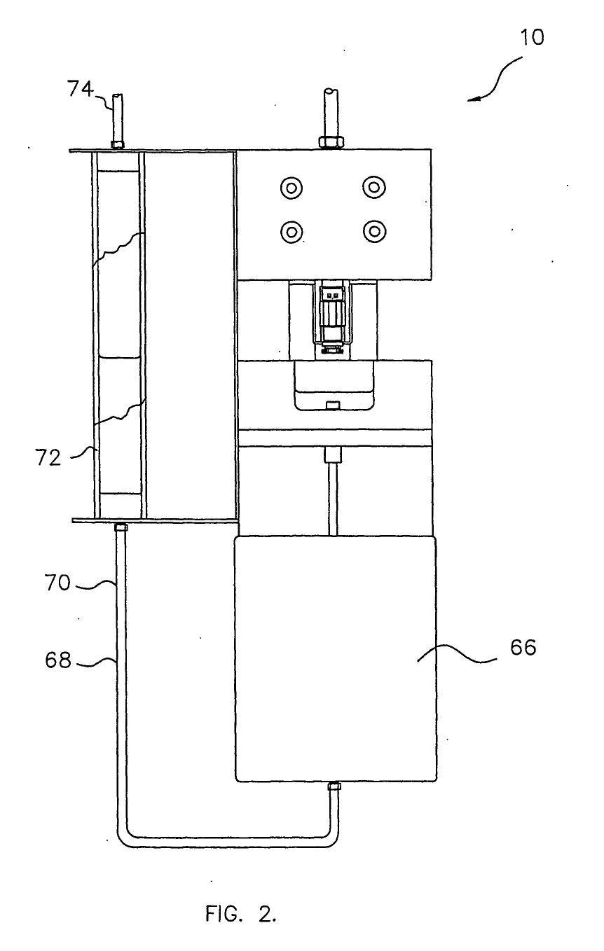

FIG. 2 is a part sectional part front view of the tester shown in FIG. 1 viewed in the direction A shown in FIG. 1;

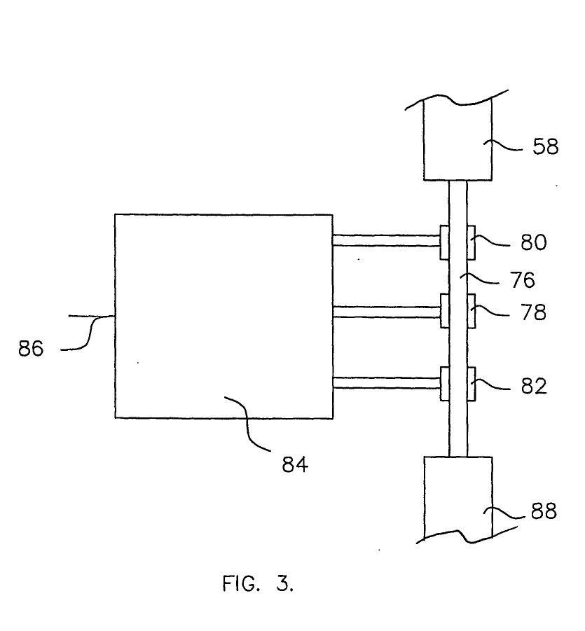

FIG. 3 is a diagrammatic illustration of a flowmeter of the tester shown in FIGS. 1 and 2;

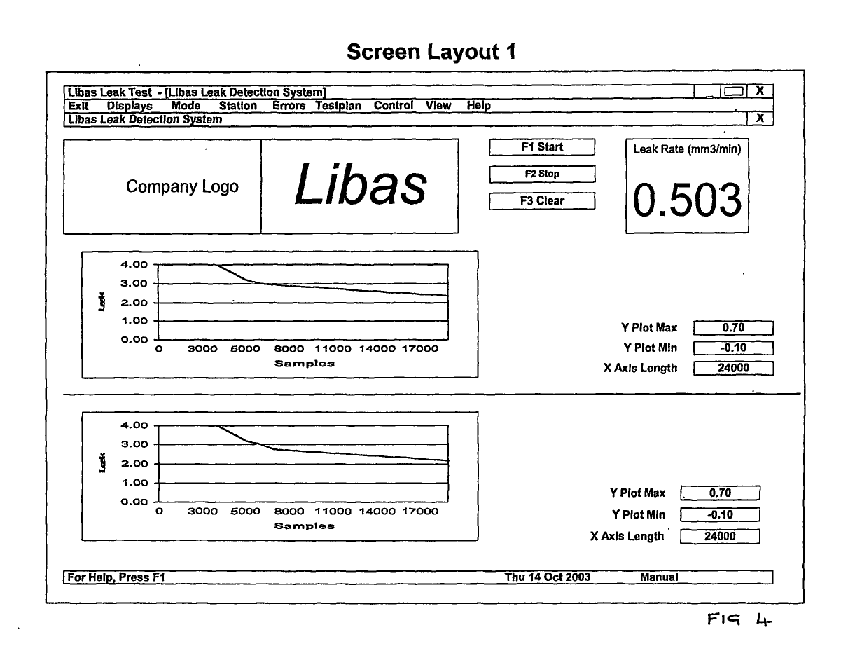

FIG. 4 shows explanatory graphs; and

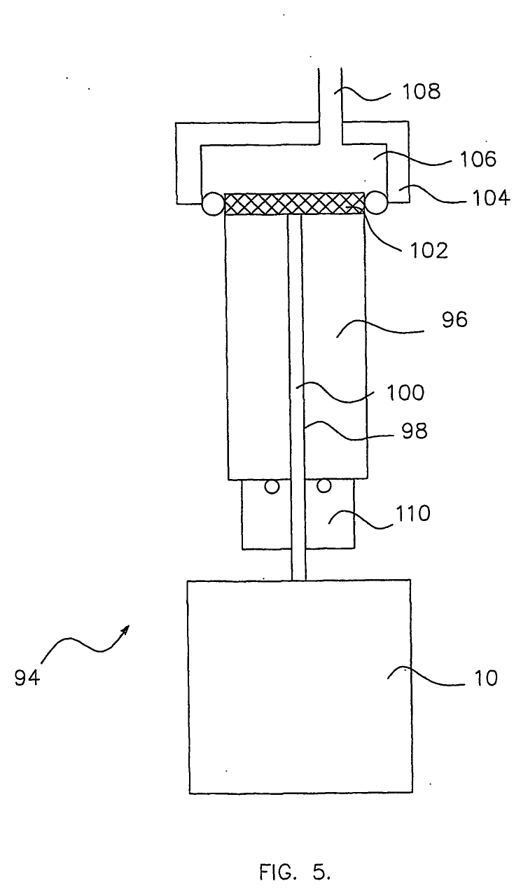

FIG. 5 is a diagrammatic illustration of a master leak for use with the tester shown in FIGS. 1 and 2.

The automotive fuel injector tester 10 shown in FIGS. 1 and 2 comprises a support base 12 having a front mounting face 14 which is on a slope and on which are secured slide tracks 16. These tracks therefore are also on a slant when the support base 12 is secured in place with its lowermost face 18 secured horizontally. On respective upper ends of the tracks 16 is mounted a slide 20 which is able to freely slide up and down the tracks 16. A mount block 22 is attached to the slide 20. The mount block 22 is formed with a throughbore 24, to an upper end of which is secured a test oil pipe 26 which provides a source of test oil under pressure to the bore 24 and sealingly engages the mount block 22 at the upper end of the bore 24. The mount block 22 is also provided with a seal 28 at the lower end of the bore 24. This seal 28 is adapted to receive the upstream end 30 of an automotive fuel injector 32 in such a fashion as to provide a sealed fluid communication between the bore 24 and the interior of the injector 32. Thus, the nozzle end 34 of the injector 32 projects downwardly with the injector mounted on the mount block 22 as shown in FIGS. 1 and 2.

A rearwardly projecting lug 40 extends from the slide 20 and is connected to a pneumatic piston and cylinder arrangement 42 in such a fashion that the latter is able to effect longitudinal movement of the slide 20, and with it the mount block 22 and injector 32 up and down along the tracks 16. It will be appreciated in this respect that the axis of the bore 24 and also of the injector 32 are co-linear and are parallel with the tracks 16. This axis is approximately 60° to the horizontal and may vary in dependence on the geometry of the injector tip.

A further slide 44 is mounted on the tracks 16, and in this embodiment the slide 44 is fixed in position thereon. A bath 46 is attached to the slide 44 and is provided with a generally cylindrically shaped hollow 48 (in this embodiment) with a generally flat base 50. The bath 46 is open at its top. The axis of the cylindrically shaped hollow is co-linear with that of the injector 32 and the bore 34. Extending downwardly from the flat base 50 of the bath 46 is a tube 52. The latter projects through the base 50 and projects a little upwardly into the hollow 48 at its upper end 54.

The end 54 is shown in greater detail in FIG. 1a. The tube 52 has an outer longitudinal tubular wall 56 through the centre of which extends a capillary tube 58 with packing material 60 supporting the capillary tube 58 in the centre of the tubular wall 56. The top end of the capillary tube 58 opens into a mouth 62 at the upper end 54 of the tube 52. This upper end 54 is generally flat and is provided with an annular sealing ring 64 surrounding the mouth 62. Clearly therefore the capillary tube 58 is co-linear with the axis of the injector 32 and the axis of the bore 24.

The capillary tube 58 extends downwardly to a flowmeter 66 and is in fluid communication at the lower end of the flowmeter 66 with a flexible pipe 68 having an upper end, on a limb 70 thereof which extends beside the flowmeter 66, sealingly connected to the lower end of an elongate upright hollow column 72. The upper end of the latter is sealingly connected to a pipe 74 which is connected to a source of gas, the pressure of which can be adjusted by means not shown.

The interior of the flowmeter 66 is shown in greater detail, albeit diagrammatically, in FIG. 3. The capillary tube 58 is connected to a flow measurement tube 76 having a diameter in the range of 10 to 200 microns, depending upon the application, so as to enable the flowmeter to be sensitive to very low flow rates. A heating element 78 is thermally coupled to the centre of the flow measuring tube 76. Two thermocouples or temperature sensors 80 and 82 are also thermally coupled to the flow measurement tubes 76 respectively upstream and downstream of the heating element 78 equidistantly therefrom. The heating element 78 is connected to a control and measurement circuit 84 as are the wires of the thermocouples 80 and 82. The circuit 84 has a digital output 86 for a computer to enable a visual display of the output signal to be provided. This output signal is indicative of the flow rate of fluid through the flow measurement tube 76. The lower end of the flow measurement tube 76 is connected to a further capillary tube 88 which in turn is connected in fluid communication with a flexible pipe 68. Alternatively, a micro turbine meter could be used.

FIG. 4 shows the screen of a computer connected to receive output signals from the digital output 86 of the circuit 84. Whilst the lower graph in FIG. 4 is simply a copy of the upper graph, it is preferably on a magnified vertical scale. The vertical scale here is the flow rate and the horizontal scale represents time so that flow rate is that of liquid flowing through the flowmeter tube 76 shown as a function of time.

The bath 46 shown in FIGS. 1 and 2 is partially filled with test oil constituting a first liquid. It is the same liquid as is supplied by the pipe 26 which fills the bore 24 and the interior of the injector 32.

The mouth 54, the capillary tube 58, the flow measurement tube 76, the capillary tube 88, the flexible pipe 68 and a lower portion of the hollow column 72 are filled, preferably with water constituting a second liquid. The water is filtered water of a high degree of cleanliness, to avoid contaminating the flowmeter 66.

Thus, the first and second liquids are immiscible. The interface between the first and second liquids is at the mouth 62.

With the injector 32 mounted in the mount block 22 as shown in FIGS. 1 and 2 ready for a test, and with any air contained in the bore 24 and the interior of the injector 32 having been bled out, and with the level of the water in the column 72 slightly above that in the bath 46, and the air above the water in the column being at ambient pressure, the slide 20 and with it the mount block 22 and injector 32 are slowly lowered by means of the piston and cylinder arrangement 42 so that the slide 20 slides downwardly along the tracks 16 and the injector 32 moves longitudinally downwardly on a slant in the direction of its longitudinal axis. As it approaches the upper end 54 of the tube 52, it contacts the upper surface 90 of the test oil 92 in the bath 46 on one side of the injector nozzle end 34 of the injector 32. As the downwardly slanting movement of the injector 32 continues, the contact lines between the injector end face 34 and the surface of the test oil 92 sweeps across that end face so that any air which may otherwise be trapped in the injector end 34 is swept out and released before the nozzle end 34 comes into sealing engagement with the upper end 54 of the tube 56. At this stage, the annular seal 64 is in sealing contact with an end face of the nozzle end 34 of the injector 32.

The pressure of the test oil in the pipe 26 is now increased by means (not shown), and any leakage through the nozzle of the injector 32 at the nozzle end 34 now starts to displace the water in the capillary tube 58. As it does so, the interface between the two liquids moves downwardly along the capillary tube 58. At the same time, displaced water flows downwardly through the flow measurement tube 76.

The thermocouple 80 provides a measure of the temperature of the incoming water through the tube 76 and the thermocouple 82 provides a measure of heat transfer from the heating element 78 in a downward direction by virtue of the flow of the water. A mapping between the signals given from the thermocouples 80 and 82 and the flow of fluid through the tube 76 is stored in a memory provided in the circuit 84 so that ultimately a digital output signal is issued along the output 86 to a computer (not shown) to provide a measure of the leakage flow rate. Thus, the temperature of the incoming water is allowed for in the determination of the flow rate.

FIG. 4 shows the flow rate of water as a function of time through the flow measurement tube 76. After an initial sharp increase in flow rate at the connection stage and increase in pressure in the bore 24, the system settles into a quiescent state which reflects accurately the leakage flow rate. If this reading is unacceptably high, the injector fails the test.

Shortly after the quiescent state has been reached and a satisfactory test has been made, the injector is raised by means of the piston and cylinder arrangement 42 and pressure is applied to the surface of the water in the column 72 via the pipe 74 of the flowmeter 66 to urge the flow in the reverse direction. This is continued until the total amount of water flowing in the reverse direction as measured by the integral of the output signal at the output 86 as a function of time, is equal to the amount of water that flowed in the downward direction during the test. This ensures that the interface between the two liquids ends up back at the mouth ready for the next test.

It will thus be appreciated that the capillary tube 58 constitutes an interface passageway. The timing of the test and the diameter of the capillary tube 58 are such as to ensure that test oil never reaches the flow measurement tube 76 so that the latter is never fouled by test oil which could leave a deposit on the interior of the tube 76, thus reducing the effective diameter of that tube, which in turn would render the output signal from the output 86 inaccurate. In the event of the computer (not shown) indicating a total volume of flow through the tube 76 since a given test began exceeding a preset value, it will cause the test procedure to be aborted, to ensure test oil does not reach the tube 76.

The master leak 94 shown in FIG. 5 comprises a solid cylinder 96 which is formed with a throughbore 98. A fine capillary tube 100 is fixed within the throughbore 98. The upper end of the fine diameter capillary tube 100, when in a vertical position, is fitted with a filter 102. An upper fixture 104, containing test liquid 106, is sealingly connected to the upper end of the solid cylinder 96.

A large diameter capillary tube 108 containing test liquid 106 is sealingly engaged with and extends upwardly from the upper fixture 104. The upwardly extending large diameter capillary tube 108 provides a pressure within the upper fixture 104 which can be precisely controlled.

The lower end of the fine diameter capillary tube 100 sealingly engages a lower fixture 110 allowing fluid communication with the automotive fuel injector leakage tester 10 when being tested.

The master leak is designed to have a similar outline to the production tester.

Numerous variations and modifications to the illustrated apparatus may occur to the reader without taking it outside the scope of the present invention. To give one example only, the slide 44 along with the bath 46 and the flowmeter 66 could be raised instead of lowering the slide 20 along with the mount block 22 and the injector 32, or both slides 20 and 44 could be moved, provided there is an overall relative movement along the injector axis between the bath 46 and the injector 32 to bring the nozzle end 34 into and out of sealing engagement with the upper end 54 of the tube 52. The computer (not shown) which provides the screen may make the check automatically, with a pass/fail indication. The latter may effect operation of an automatic injector changer (not shown) to pass or reject an injector automatically before the next injector is automatically mounted on the tester.

Liquids other than test oil and water may be used for optimum results, depending upon the nature of the injector being tested.

It will be appreciated that the illustrated tester is less subject to surface tension effects. The absence of any air in the measurement region eliminates the effects of the compressibility of air.

1. An automotive fuel injector leakage tester (10) comprising a mount (22) for such an injector and a flowmeter (66) of sufficient sensitivity arranged to measure leaked fuel flow rates through the nozzle (34) of such an injector (32), characterised in that the tester (10) is further provided with an interface passageway (58) which enables fluid communication between the injector nozzle (34) and the flowmeter (66) when the tester (10) is in use, in which such an injector (32) contains a first liquid when under test to supply such liquid to the injector nozzle (34) so that such liquid can leak therethrough into the interface passageway (58), and in which the interface passageway (58) contains a second liquid which is immiscible with the first liquid, the tester (10) being so constructed that the interface between the first and second liquids remains within the interface passageway (58) whilst the flowmeter (66) provides a measure of the leakage of the first liquid through the nozzle (34) of such an injector (32).

2. An automotive fuel injector leakage tester according to claim 1, characterised in that the flowmeter also contains the said second liquid, so that it provides a measure of the leakage flow rate through the nozzle (34) of the injector (32) under test by virtue of displacement of the second liquid through it owing to the said first liquid displacing some of the said second liquid from the interface passageway (58).

3. An automotive fuel injector leakage tester according to claim 1, characterised in that the injector (32) is positioned above the interface passageway (58) with the said first liquid being of a lower density than the said second liquid.

4. An automotive fuel injector leakage tester according to claim 1, characterised in that the said first liquid comprises a test oil.

5. An automotive fuel injector leakage tester according to claim 1, characterised in that the said second liquid comprises water.

6. An automotive fuel injector leakage tester according to claim 1, characterised in that the flowmeter (66) comprises a measurement passageway (76) of sufficiently small cross-section to enable a flow rate to be measured which is as low as automotive fuel injector leakage flow rates.

7. An automotive fuel injector leakage tester according to claim 1, characterised in that the flowmeter (66) measures flow rates via heat transfer detection means (80,82, 84) which serve to detect heat transferred by liquid passing through the measurement passageway (76), to provide a measure of the flow rate thereof.

8. An automotive fuel injector leakage tester according to claim 7, characterised in that the measurement passageway (76) is provided with a heating element (78) positioned to heat fluid within the measurement passageway (76), and a temperature sensor (82) is provided downstream of the heating element (78) to provide an output which is indicative of the flow rate.

9. An automotive fuel injector leakage tester according to claim 8, characterised in that the temperature sensor (82) comprises a thermocouple (82).

10. An automotive fuel injector leakage tester according to claim 8, characterised in that a further temperature sensor (80) is arranged upstream of the heating element (78) to provide a measure of the temperature of liquid flowing within the measurement passageway (76) before it reaches the heating element (78).

11. An automotive fuel injector leakage tester according to claim 10, characterised in that the further temperature sensor (80) comprises a thermocouple (80).

12. An automotive fuel injector leakage tester according to claim 11, characterised in that the flowmeter (66) takes account of the temperature of the incoming liquid, and adjusts the output from the first temperature sensor (82) accordingly so that the output of the flowmeter (66) is substantially independent of the temperature of the incoming liquid.

13. An automotive fuel injector leakage tester according to claim 12, characterised in that the roles of the two temperature sensors (80,82) are selectively reverseable so that the flowmeter (66) can measure flow rates of liquids in both directions of flow through the measurement passageway (76).

14. An automotive fuel injector leakage tester according to claim 1, characterised in that the flowmeter (66) comprises a micro turbine.

15. An automotive fuel injector leakage tester according to claim 1, characterised in that the interface passageway (58) comprises a tube (58) connected to the flowmeter (66) at one of its ends, and provided with a seal (64) at its other end adapted for sealing engagement with the nozzle end (34) of such an injector (32).

16. An automotive fuel injector leakage tester according to claim 1, characterised in that a reverse feed device (70,72, 74) is connected in fluid communication with the flowmeter (66) on the other side thereof to that of the injector (32).

17. An automotive fuel injector leakage tester according to claim 16, characterised in that the reverse feed device (70,72, 74) comprises a reservoir (72) of the said second liquid to an upper surface of which is connected a source of pressurised gas to force the flow of fluid through the flowmeter (66) in the reverse direction to which such fluid flows through the flowmeter (66) during a leakage measurement.

18. An automotive fuel injector leakage tester according to claim 17, characterised in that a control is provided to ensure that the amount of liquid flowing through the flowmeter (66) in the second direction is equal to the amount of fluid which flowed through it during the leakage measurement.

19. An automotive fuel injector leakage tester according to claim 1, characterised in that the amount of liquid which flows through the flowmeter in the second direction returns the interface between the two liquids to the seal end (64) of the interface passageway (58).

20. An automotive fuel injector leakage tester according to claim 1, characterised in that a drive (42) is provided to bring about relative linear movement between the injector (32) and the interface passageway (58) to bring them into and out of sealing engagement with one another.

21. An automotive fuel injector leakage tester according to claim 1, characterised in that the tester (10) has a bath (46) of the said first liquid, and that end of the interface passageway (58) which is brought into contact with the injector (32) is immersed in that bath (46).

22. An automotive fuel injector leakage tester according to claim 21, characterised in that the axis of the injector (32) is aligned with the direction of relative movement between the injector (32) and the interface passageway (58), the nozzle end (34) of the injector (32) has a face which is generally transverse of that axis, and the line of movement is on a slant so that as the nozzle end (34) of the injector (32) dips into the bath (46) of the said first liquid, the line of contact between the generally horizontal surface of that liquid and the nozzle end (34) of the injector (32) sweeps across the face thereof, and more readily enables removal of air that might otherwise become trapped between the nozzle end (34) of the injector (32) and the interface passageway (58).

23. A method of testing an automotive fuel injector for leakage, characterised in that a tester (10) is used which is as claimed in claim 1.

24. A method of testing an automotive fuel injector for leakage, characterised in that a first liquid is allowed to leak from the nozzle (34) of an injector (32) under test into an interface passageway (58) which contains a second liquid and which provides fluid communication between the injector nozzle (34) and a flowmeter (66), the second liquid being immiscible with the first, and the interface between the first and second liquids remaining within the interface passageway (58) whilst the flowmeter (66) provides a measure of the leakage of the first liquid through the nozzle (34) of such an injector (32).

25. A method of bringing about a sealing engagement between two components and in such a fashion as to reduce the likelihood of air being trapped between them, characterised in that the two components (32 and 58) are brought together by relative linear motion along a first imaginary line which is on a slant, and in which one end of the lower of the components is immersed in a bath (46) of liquid, and in which the upper (32) of the components has an end face (34) which is transverse of that line, so that a second imaginary line, being the line of contact between the surface of the liquid and the said end face (34) as the latter dips into the bath (46) sweeps across that end face enabling air which would otherwise be trapped between the two components (32 and 58) before they are brought together to escape.

26. An automotive fuel injector leakage tester (10) comprising a mount (22) for such an injector (32) and a flowmeter (66) of sufficient sensitivity arranged to measure leaked fuel flow rates through the nozzle of such an injector, characterised in that the flowmeter (66) comprises a measurement passageway (76) of sufficiently small cross-section to enable a flow rate to be measured which is as low as automotive fuel injector leakage flow rates, and heat transfer detection means (80,82, 84) which serve to detect heat transferred by liquid passing through the measurement passageway (76), to provide a measure of the flow rate thereof.

27. An automotive fuel injector leakage tester according to claim 26, characterised in that the same fluid is used for the fluid which passes at leakage flow rates through the nozzle (34) of the injector (32), as the fluid which passes through the flowmeter (66).

28. An automotive fuel injector leakage tester according to claim 27, characterised in that the fluid comprises water.

29. An automotive fuel injector leakage tester according to claim 27, characterised in that comprises alcohol.

30. A master leak (94) for use in calibrating an automotive fuel injector leakage tester (10), characterised by a capillary tube (100) and pressure regulating means (106) connected to apply pressure to a fluid within the capillary tube (100).

31. A master leak (94) according to claim 30, characterised in that the master leak (94) has an outer shape which corresponds to that of an automotive fuel injector (32).

32. A master leak according to claim 30, characterised in that it is provided with a filter (102) to inhibit blockage of the capillary tube (100).

33. A master leak according to claim 30, characterised in that it is provided with an upper seal to simulate an injector upper seal.

34. A master leak according to claim 30 in that the pressure regulating means comprise a regulator valve.

35. A master leak according to claim 30, characterised in that the pressure regulating means comprise a head of fuel in a tube (108).

36. A master leak according to claim 30, characterised in that the capillary tube (100) has a diameter of between 0.2 mm and 0.025 mm.
